(19) United States
(12) Patent Application Publication
(10) Pub. No.: US 2019/0318673 A1
(43) Pub. Date: Oct. 17, 2019

(54) INFLATABLE DECORATION AND BASE

(71) Applicant: MICHAEL SCOTT NEWTON, (US)

(72) Inventors: MICHAEL SCOTT NEWTON, DENVER, NC (US); FARRAH McCORMICK, HUNTERSVILLE, NC (US)

(21) Appl. No.: 16/160,890

(22) Filed: Oct. 15, 2018

Related U.S. Application Data
(60) Provisional application No. 62/573,638, filed on Oct. 17, 2017.

(51) Int. Cl. G09F 19/08; F16M 11/26

(52) U.S. Cl. CPC G09F 19/08; A63H 3/06; F16M 11/26

(57) ABSTRACT

A holiday decoration includes an inflatable figure in the shape of a holiday icon. The lower end of the inflatable figure is located inside a base having upstanding side walls and a hinged lid. A fan is arranged to blow air into the figure to inflate the figure and to keep it inflated. A vertically telescoping pole is located within the figure. Straps or rings connect the upper end of the telescoping pole to the inner wall of the inflatable figure proximate the upper end of the inflatable figure. When the blower is turned off and the figure deflates, the vertical pole telescopes downward under the weight of the collapsing figure. The straps connecting the telescoping pole to the inner surface of the figure ensure that the figure collapses substantially straight down into the base as it deflates.

### CROSS REFERENCE TO RELATED APPLICATIONS

This application claims priority of U.S. Provisional Patent Application Ser. No. 62/573,638, filed Oct. 17, 2017.

### BACKGROUND OF THE INVENTION

### Technical Field

The present invention relates generally to inflatable figures that can be used as indoor or outdoor decorations and especially as holiday decorations. More specifically, the invention relates to an apparatus for controlling such inflatable figures when deflating, such that the inflatable figure collapses in a controlled manner into a base.

### Background Art

Inflatable devices in the shape of seasonal figures are well known for use as holiday decorations. Such inflatables typically comprise an air bladder, or “inflatable figure,” configured in a holiday motif, for example, a snowman, a Santa Claus figure, a Halloween pumpkin, or the like. When the device is to be displayed, a blower is turned on to inflate the figure. During those periods when display of the device is not desired, the blower can be turned off, permitting the figure to deflate. When it is time for the figure to be displayed again, the blower is turned on to reinflate the device.

A disadvantage of such prior art inflatable holiday decorations is that, when the blower is turned off, the figure simply collapses in a haphazard manner, leaving an unsightly pile of fabric lying on the ground. Also, because the manner in which the figure collapses can be unpredictable, any objects in close proximity to the collapsing decoration can be damaged or overturned. Further, if the figure collapses in an uncontrolled manner onto a nearby object, the inflatable figure can be punctured, causing an air leak that makes it difficult or impossible to keep the figure inflated.

Another disadvantage of known inflatable decorations is that their large surface area and light weight make them easily toppled or blown around in a breeze. Thus, when installing these inflatables, the decoration typically must be tied down with stakes and cords. The stakes and cords complicate setup of the decoration and can present a tripping hazard to anyone walking in close proximity to the decoration.

Still another disadvantage of known inflatable decorations is the difficulty of storing them during the offseason. In some instances the user can spread out the deflated decoration, fold it or roll it up, and place it in a protective bag or box. More often, however, the decoration is simply stored unprotected, e.g., on a shelf or on the floor of the garage or basement. This haphazard storage makes it easy for the decoration to sustain punctures, rips, cosmetic blemishes, or other damage.

### BRIEF SUMMARY OF THE INVENTION

The present invention relates to a holiday decoration having an inflatable figure in the shape of a holiday icon. The lower end of the inflatable figure is located inside a base sufficiently large to contain the inflatable figure when the figure is in a deflated condition. A blower associated with the inflatable figure is switchable between an inflation mode in which the blower is operative to force air into the figure to inflate it, and a deflation mode in which the blower allows the inflatable figure to deflate.

A guiding means, a major portion of which is disposed within the inflatable figure, guides the collapse of the inflatable figure when the blower is switched from the inflation mode to the deflation mode. The upper end of the guiding means is attached to the inner surface of the inflatable figure proximate the upper end of the figure, and the lower portion of the guiding means is disposed within the base. When the inflatable figure deflates, the guiding means guides the inflatable figure to collapse into the base.

In a disclosed embodiment the guiding means is a telescoping pole.

In one embodiment the blower's deflation mode comprises the blower being off. In another embodiment the blower's deflation mode comprises the blower operating in reverse to draw air out of the figure to facilitate deflation. As an alternative, a second blower configured to draw air out of the figure can be actuated when the first blower is powered off.

In one embodiment the base includes a hinged lid and a means for closing the lid a predetermined period of time after the blower is turned off. Thus, after the figure has collapsed into the base, the lid closes to hide the deflated figure.

Thus it is an object of the present invention to provide an improved holiday decoration with inflatable figure.

It is another object of the present invention to provide a holiday decoration with a base and an inflatable figure in which the inflatable figure collapses into the base in a controlled manner upon deflation.

Another object of the present invention is to provide a holiday decoration with an inflatable figure in which the deflated figure is protected from damage when not in use.

Still another object of the present invention is to provide a holiday decoration with a base and an inflatable figure in which the deflated figure is concealed inside the base for aesthetic reasons when not in use. Other objects, features, and advantages of the invention will become apparent upon reading the following disclosure in light of the appended claims.

### BRIEF DESCRIPTION OF THE SEVERAL VIEWS OF THE DRAWINGS

FIG. 1 is a front view of an inflatable holiday decoration and base, according to a disclosed embodiment of the invention.

FIG. 2 is a side view of the inflatable decoration and base of FIG. 1.

FIG. 3 is a rear view of the base of FIG. 1.

FIG. 4 is a side view of the inflatable decoration and base of FIG. 1, with the inflatable decoration inflated and shown in phantom lines to reveal interior detail.

FIG. 5 is a side view of the inflatable decoration and base of FIG. 1, with the inflatable decoration partially deflated and shown in phantom lines to reveal interior detail.

FIG. 6 is a side view of the inflatable decoration and base of FIG. 1 with the inflatable decoration fully deflated and collected into the base and showing the lid of the base open.

FIG. 7 is a side view of the base of FIG. 1 with deflated decoration stored therein and the lid to the base closed.

FIG. 8 is a side view of an automatic lid-closing device of the inflatable decoration and base of FIG. 1, with the device in a first position.

FIG. 9 is a side view of the automatic lid-closing device of FIG. 8, depicting the device in a second position.

FIG. 10 is a side view of the automatic lid-closing device of FIG. 8, showing the device in a third position.

FIG. 11 is a side view of the automatic lid-closing device of FIG. 8, with the device in a fourth position.

FIG. 12 is a side view of the automatic lid-closing device of FIG. 8, showing the device in a fifth position.

FIG. 13 is an isometric view of an inflation blower of the inflatable holiday decoration and base of FIG. 1.

FIG. 14 is an isometric view of a deflation blower of FIG. 13, showing a damper in an open position.

FIG. 15 is an isometric view of the deflation blower and damper of FIG. 14, showing the damper in a closed position.

FIG. 16 is a schematic layout representing various components of the inflatable decoration and base of FIG. 1 and showing the electrical connections between the components.

FIG. 17 is a flowchart depicting the process steps and decisions of an algorithm for operation of the inflatable decoration and base of FIG. 1.

FIG. 18 is a flowchart illustrating the process steps and decisions of an algorithm for deflating the inflatable decoration and base of FIG. 1.

FIG. 19 is an isometric view of an alternate embodiment of an inflatable holiday decoration, with the inflatable figure shown in dashed lines to reveal interior detail.

FIG. 20 is a top view of an alternate arrangement for slidably securing the inflatable figure of FIG. 19 to a telescoping pole.

FIG. 21 is an isometric view of another embodiment of an inflatable decoration, with the inflatable figure shown in phantom lines to reveal interior detail.

FIG. 22 is an isometric view of still another embodiment of an inflatable decoration, with the inflatable figure shown in phantom lines to reveal interior detail.

### DETAILED DESCRIPTION OF THE INVENTION

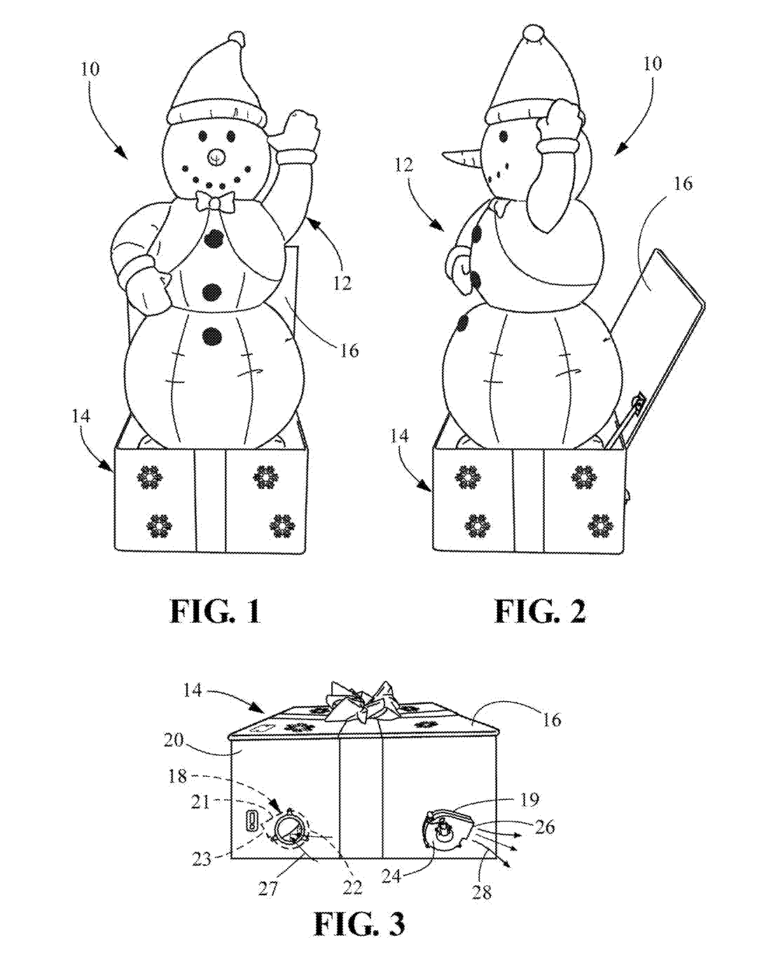

Referring now to the drawings, in which like numerals indicate like elements throughout the several views, FIGS. 1 and 2 show an inflatable holiday decoration 10. The holiday decoration 10 includes an inflatable FIG. 12 and a base 14. In the disclosed embodiment the inflatable figure takes the appearance of a snow man. The base 14 is in the shape of a box with a hinged lid 16. In the disclosed embodiment the base 14 takes the appearance of a gift-wrapped holiday package. The lower end of the inflatable FIG. 12 is located in the bottom of the base 14.

Referring to FIG. 3, first and second blowers 18, 19 are mounted to the rear panel 20 of the base 14. In a disclosed embodiment the blowers 18, 19 are centrifugal fans. The first blower 18 has a fan housing 21, an air inlet 22, and an air outlet 23. The second blower 19 has a fan housing 24, an air inlet 25 (not visible in FIG. 3; see FIG. 14), and an air outlet 26. The first blower 18 is arranged so that its fan housing 21 is mounted to the inside of the rear panel 20, with its air inlet 22 located outside the base 14, and the air outlet 23 located inside the FIG. 12. When the first blower 18 is operating, it draws air from the ambient, as indicated by the arrows 27, and blows the air into the inflatable FIG. 12 to inflate it. The second blower 19 is arranged so that its fan housing 24 is mounted to the outside of the rear panel 20, with its air inlet located inside the inflatable FIG. 12, and its air outlet 26 expelling air to the outside of the base 14. Thus when the second blower 19 is operating, it draws air out of the inflatable FIG. 12 and expels it to the ambient, as indicated by the arrows 28, to deflate the figure.

Based on their functions as just described, the first blower 18 may be referenced herein as the inflation blower, and the second blower 19 may be referenced as the deflation blower.

Also visible on the back panel 20 in FIG. 3 is an interface panel 29, whose function will be explained below.

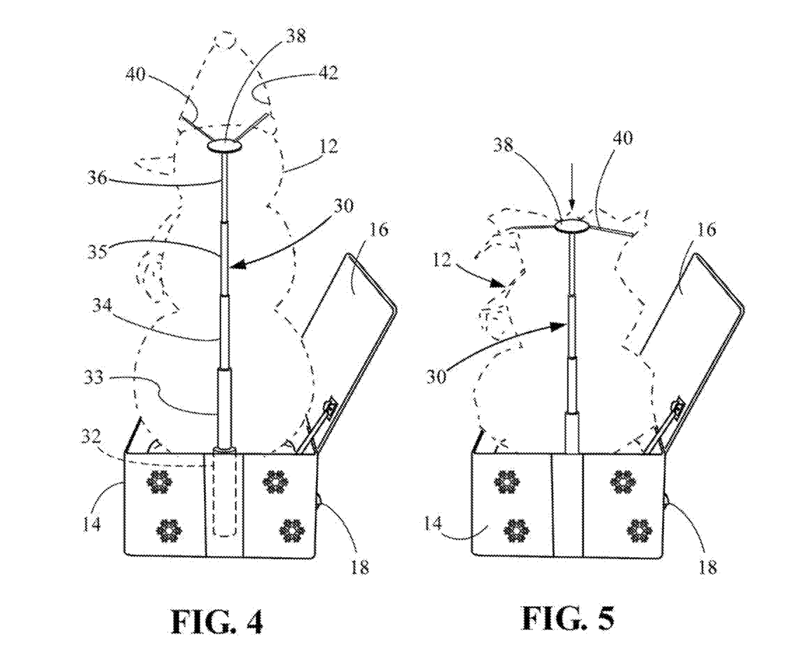

FIGS. 4 and 5 show a telescoping pole 30 mounted inside the inflatable FIG. 12. The bottom of the telescoping pole 30 rests in the base 14 inside the inflatable FIG. 12. The lowermost section 32 of the pole 30 is mounted vertically in a fixed position. The other pole sections 33-36 telescope into one another and the lowermost section 32.

The telescoping pole 30 has a head 38 at its upper end. A plurality of straps 40 each have a first end mounted to the head 38 of the telescoping pole 30. The opposite ends of the straps 40 are connected to the inner wall 42 of the inflatable FIG. 12 at an upper section of the figure.

The lower end of the telescoping pole 30 is mounted to the floor of the base 14. Alternatively, for a base 14 that does not have a floor, the lower end of the telescoping pole may be driven into the ground. In the latter case the bottom of the telescoping pole 30 may actually be below, rather than within, the base 14. However, in either case a “lower portion” of the telescoping pole 30 is located within the base 14.

The dimensions of the telescoping pole 30 depend upon the configuration of the inflatable FIG. 12. For the embodiment illustrated in FIGS. 1-5, the inflatable snowman FIG. 12 is about nine feet tall. Consequently the telescoping pole 30 when fully extended is about 8 feet tall. When the pole 30 is fully collapsed, it is about 16 inches (40 cm) tall. The telescoping pole 30 of the particular disclosed embodiment has nine sections. The diameter of the largest pole section is about 2.6 inches (67 mm), and the diameter of the smallest pole section is about 0.8 inches (21 mm). The wall thickness of each telescoping pole section is about 0.12 inches (2.9 mm).

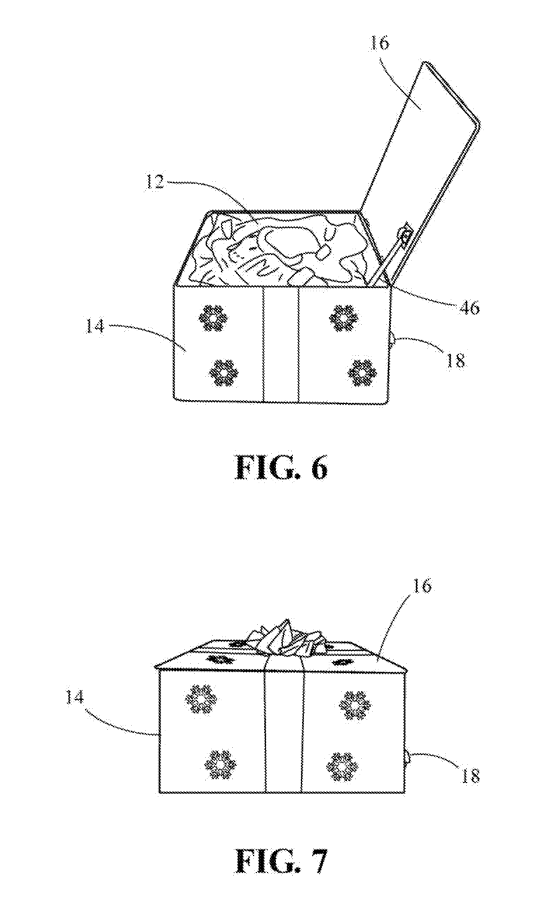

FIG. 6 shows the inflatable FIG. 12 fully deflated and contained within the base 14 with the lid 16 open. An automatic lid closer 46 is partially visible in the base 14 adjacent the location where the lid 16 is hinged. In FIG. 7 the automatic lid closer 46 has pulled the lid 16 closed.

The base 14 and lid 16 of the inflatable decoration 10 are decorated such that, when the lid is closed, the base and lid mimic the appearance of a wrapped gift box.

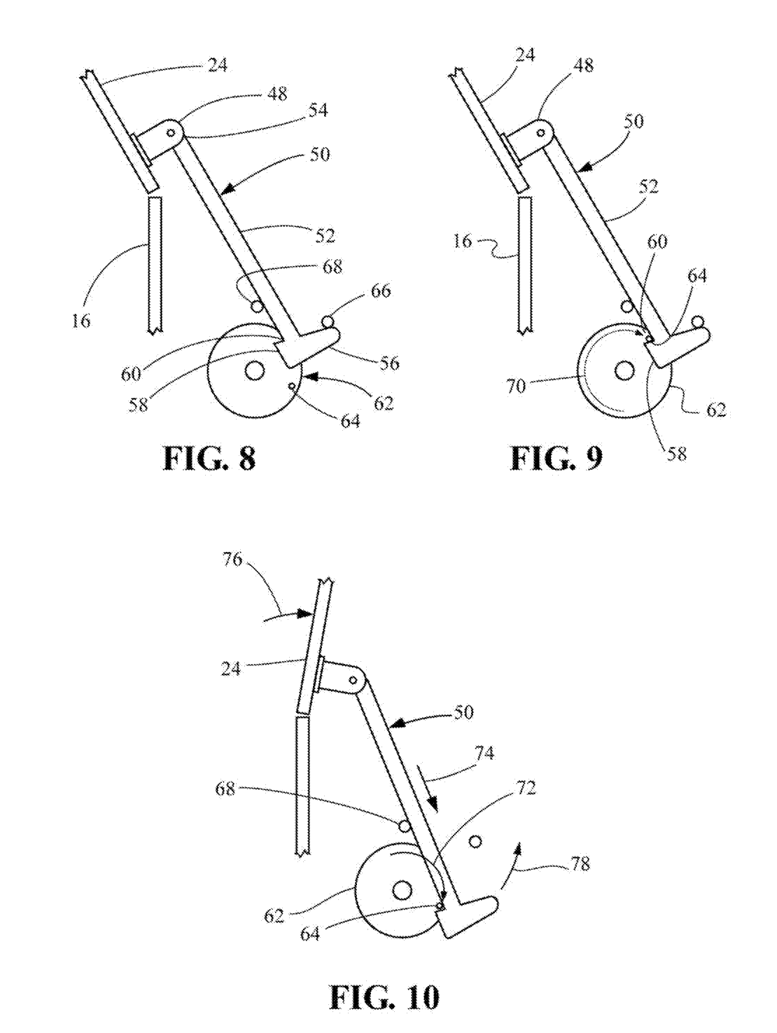

The lid closer 46 is shown in more detail in FIGS. 8-12. The lid 16 is pivotably mounted to the rear panel 24 by hinges. A bracket 48 is mounted to the inner surface of the lid 16.

A link 50 includes an elongated strut 52. The upper end 54 of the link 50 is pivotably mounted to the bracket 48 on the lid 16. At the lower end of the link 50 are a toe member 56 and a heel member 58. A notch 60 is formed between the upper edge of the heel member 58 and the adjacent edge of the strut 52.

A drive wheel 62 is rotatable by an electric motor (not shown). A pin 64 just inside the periphery of the drive wheel 62 extends perpendicular to the plane of the wheel 62. Adjacent the drive wheel 62 are a front stop 66 and a rear stop 68.

FIG. 8 illustrates the lid closer 46 in its starting position. The lid 16 is open. Whenever the lid 16 is opened past vertical (to the left of vertical, as seen in FIG. 8), gravity attempts to rotate the lid further in a counterclock-wise direction. The rear edge of the strut 52 bears against the rear stop 68 to keep the toe 56 of the link 50 in a forward position. The upper edge of the toe 56 of the link 50 engages the front stop 66 to prevent further upward motion of the link. Because the upper end of the link 50 is attached to the lid 16, the constraint on further upward motion of the link prevents the lid from opening further.

When the lid-closing sequence is initiated, the wheel 62 rotates in a clockwise direction, as indicated by the arrow 70, to the position shown in FIG. 9. The pin 64 of the wheel engages the notch 60 at the juncture of the heel 58 and the strut 52. At this point in the sequence, none of the other components of the lid closer 46 has moved.

In FIG. 10 the drive wheel 62 continues to rotate in a clockwise direction, as indicated by the arrow 72. The pin 64 on the drive wheel 62 pulls the link 50 downward, as indicated by the arrow 74. This movement of the link 50 pulls the lid 16 forward and downward, as indicated by the arrow 76. The downward movement of the lid 16 displaces the link 50 downward and pivots the link around the rear stop 68 in a counterclockwise direction, as indicated by the arrow 78, disengaging the link from the pin 64 on the drive wheel 62.

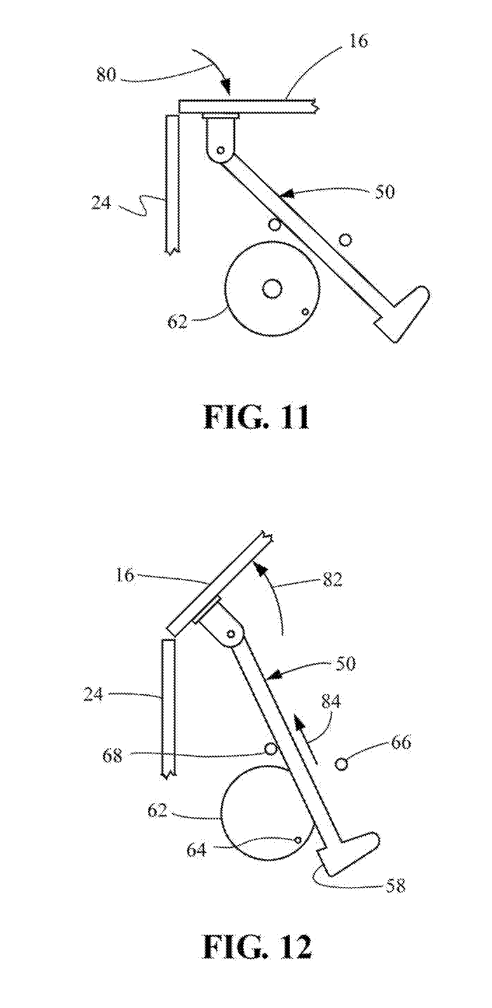

As shown in FIG. 11, once the lid 16 rotates past vertical, gravity pulls the lid the rest of the way downward to its closed position, as indicated by the arrow 80. Also at this point, a contact (not shown) associated with the drive wheel 62 triggers a relay (not shown) to stop the drive wheel in the angular orientation shown in FIGS. 8 and 11. The lid closing sequence is now complete.

The lid closer 46 does not operate during the inflation sequence. In addition, the lid closer 46 is arranged such that it does not impede the inflation sequence. FIG. 12 shows the lid closer 46 as the inflating figure pushes open the lid 16 from inside the base. As the lid 16 pivots toward its open position, as indicated by the arrow 82, the link 50 is pulled upward, as shown by the arrow 84. As the heel 58 of the link 50 is pulled upward, it passes to the right of the pin 64 without engaging. The toe 56 of the link 50 hooks beneath the forward stop 68 (see FIG. 8) to prevent the lid 16 from over rotating.

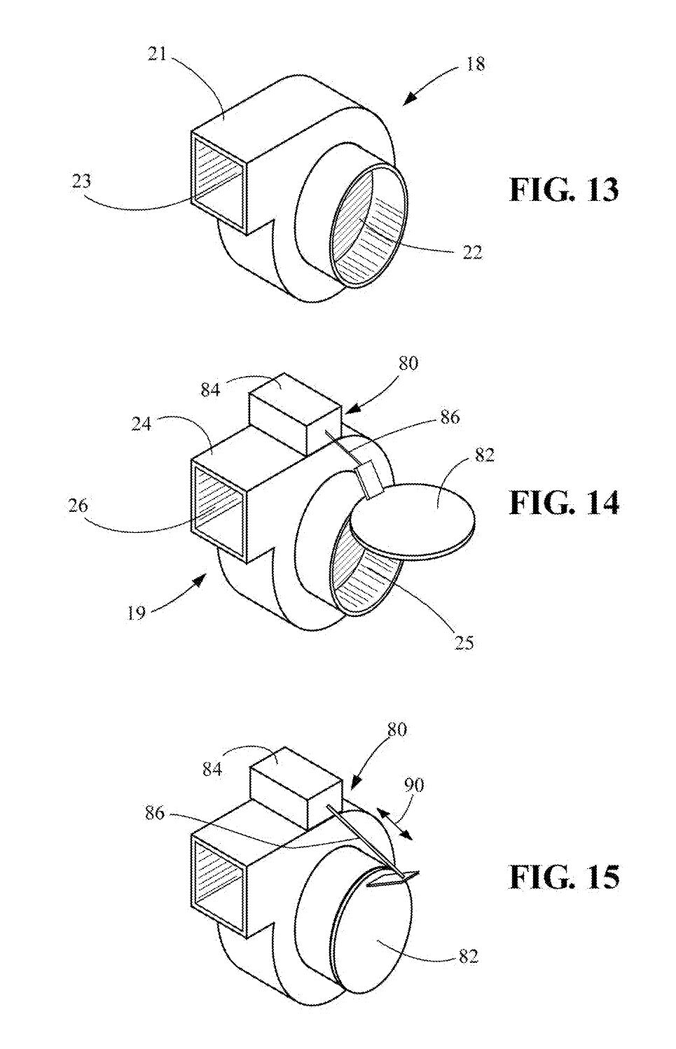

Reference is now made to FIGS. 13-15. FIG. 13 shows the inflation blower 18, with fan housing 21, air intake 22, and air outlet 23. FIG. 14 depicts the deflation blower 19, including fan housing 24, air intake 25, and an air outlet 26.

As previously explained with reference to FIG. 3, the inflation blower 18 is arranged such that, when it is powered on, it blows air into the inflatable FIG. 12 to inflate it and, once it is inflated, to keep it inflated. While the inflation blower 18 is operating, the deflation blower 19 is turned off. The idle deflation blower 19 could potentially pose a problem, in that air could escape the inflatable FIG. 12 through the deflation blower. Specifically, air could escape from inside the FIG. 12 into the air outlet 26 of the deflation blower 19, through the fan housing 24, and then out the air intake 25 to the ambient. This air leakage could inhibit or even prevent the inflatable FIG. 12 from inflating.

As FIGS. 14 and 15 illustrate, the deflation blower 19 of the disclosed embodiment is designed to address this issue. The deflation blower 19 includes an intake vent damper system 80 including a damper 82 attached by hinges to the air intake 25 of the blower 19. A solenoid 84 is mounted to the fan housing 24 and connected to the damper 82 by a linkage 86. Actuation of the solenoid 84 moves the linkage 86 as indicated by the arrow 90 to pivot the damper 82 between a closed position, shown in FIG. 14, and an open position, shown in FIG. 15. When the inflation blower 18 is operating, the solenoid 62 is actuated to close the damper 82 of the deflation blower 19, thereby preventing the escape of air through the deflation blower. When the inflation blower 18 is turned off and the deflation blower 19 is turned on to extract air from the inflatable FIG. 12, the solenoid 84 is actuated to open the damper 82.

Dampers for controlling the flow of air through a duct generally are well known, and other arrangements for opening and closing the damper 62 can be employed, including but not limited to electric motors. In addition, the damper 82 is not limited to a location that covers the air intake 25 but can alternatively be mounted to selectively cover the air outlet 26 of the deflation blower 19. As still another example, the damper can be a butterfly valve located within the air intake 25 or air outlet 26. The butterfly valve would pivot between an orientation transverse to the axis of the duct, blocking the flow of air through the duct, and an orientation parallel to the axis of the duct, in which air would flow through the duct.

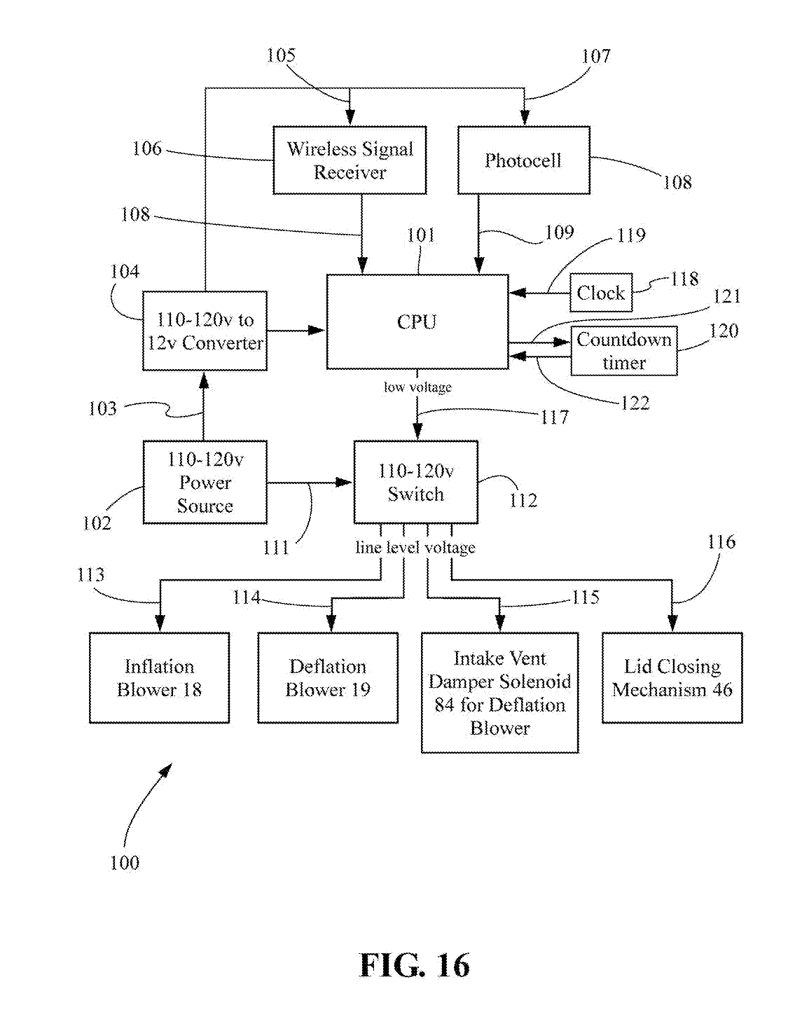

Referring to FIG. 16, the inflatable decoration 10 includes an electrical system 100. The electrical system 100 includes a central processing unit (“CPU”) 101. The system includes a power supply means 102 for supplying an electrical current, preferably 110-120 volts AC for United States use. Line level voltage is sent via path 103 to a voltage converter 104 for downconversion to a low voltage current to power the CPU 101.

A low voltage current is also sent from the voltage converter 104 via path 105 to a wireless signal receiver 106 that receives an infrared signal, an RF signal, a Bluetooth signal, or other wirelessly transmitted signal. A low voltage current is sent via a path 107 to power a photovoltaic cell 108 to sense the ambient light level. Output signals are sent from the wireless signal receiver 106 and the photovoltaic cell 108 via paths 108,109 to the CPU 101.

Optionally the wireless signal receiver 106 and photovoltaic cell 108 can be located on the control panel 29 on the back panel 20 of the base 14, as shown in FIG. 3.

Line-level (110-120 volt AC) current is sent from the power supply 102 via path 111 to a switch 112 having individually controllable outputs 113-116 for sending line level current to the inflation blower 18, the deflation blower 19, the lid closer 46, and the intake vent damper system 80. The switch 112 is controlled by the CPU 101, such as by a low voltage signal sent via path 117, to select an appropriate output 113-116.

The electrical system 100 can include a clock 118, preferably adjustable by the user, that can be set to inflate and to deflate the decoration at particular times of day. The clock 118 communicates with the CPU via signal path 119. An interface by which the user can adjust the clock 118 could be located on the control panel 29 on the rear panel 20 of the base 14, as shown in FIG. 3.

The electrical system 100 includes a countdown timer 120. The countdown timer 120 is triggered by the CPU via signal path 121 when the inflation blower 18 is turned off, to proscribe a predetermined period of time. The predetermined period of time is such as will allow the inflatable FIG. 12, once the inflation blower 18 is turned off, to completely deflate and to collapse into the base 14. Preferably the period of time is preset during manufacture and not user-adjustable. When the countdown timer 120 expires, a signal is sent via signal path 122 to the CPU 101.

The different elements of the electrical system need not necessarily be separate physical components. For example, the clock 118 and countdown timer 120 can simply be code in the CPU 101 performing the function of a clock and a timer.

The electrical system 100 does not have to include all of the components described. As an example, the electrical system does not have to include a wireless receiver 106 or a photocell 108, but can rely entirely on the clock 118 to control the period during which the inflatable decoration 10 operates. Similarly, the inflatable decoration 10 does not have to be turned on and off by the same component but rather can be based on input from various components. As an example, the inflatable decoration 10 can be turned on every day by the photocell 108, such as when the ambient light falls below 100 lux, but turned off by the clock 118, such as at midnight. Further, a simple, user-operated, on/off power switch can be located on the switch plate 29 (FIG. 3) to supplement or replace the automated controls.

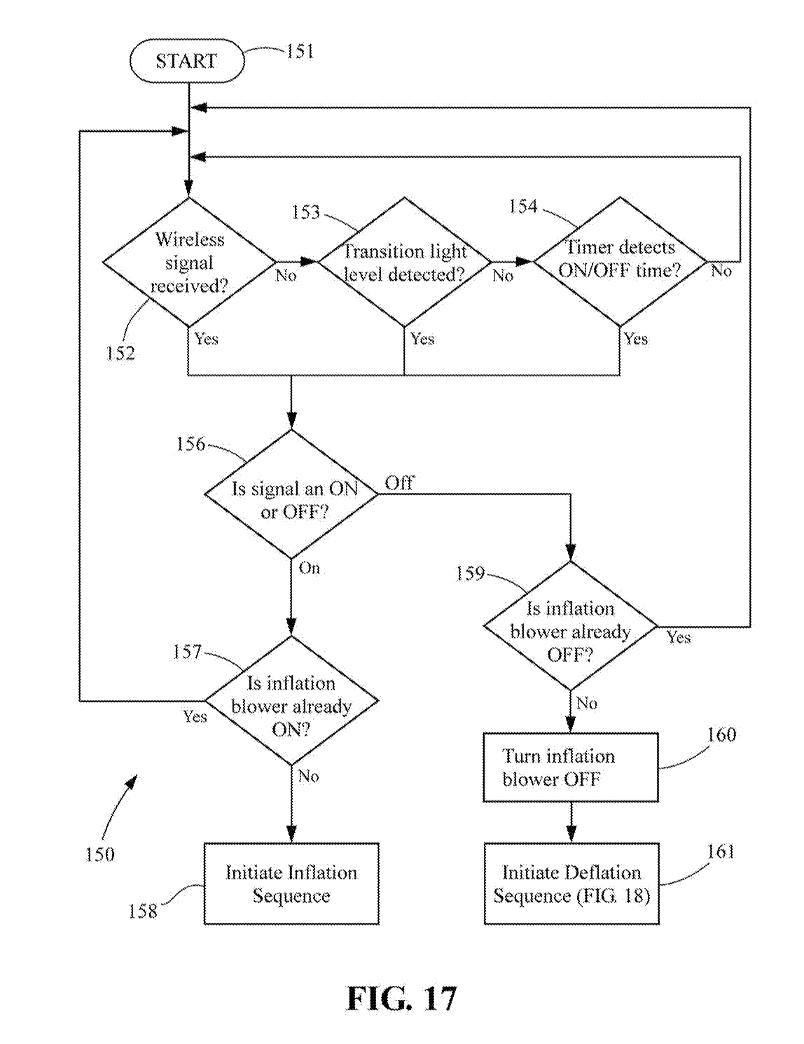

FIG. 17 is a flowchart 150 of a routine representing an algorithm that controls the general operation of the inflatable decoration 10. The program is initiated at a Start node 151. The routine then progresses to a decision node 152, in which the program monitors the wireless signal receiver 106 to determine whether a wireless signal (RF, infrared, WiFi, Bluetooth, or the like) has been received. If not, the program progresses to the next decision node 153, in which the routine monitors the photocell 108 to determine whether a threshold ambient light level has been detected. If not, the routine progresses to a next decision node 154, in which the clock 118 is monitored to determine whether a particular time of day is detected. If not, the routine returns to the decision node 152, and the routine cycles until one of the decision nodes 152-154 returns a “YES” answer.

If the node 152 determines that a wireless signal has been detected, the routine progresses to a decision node 156, in which it is determined whether the wireless signal is an “ON” signal or an “OFF” signal.

If decision node 153 determines that the photocell has detected a transition ambient light level, for example, 100 lux, the routine progresses to a decision node 157, in which it is determined whether the inflation blower 18 is already operating. If so, the output signal from the decision node 157 is set to OFF, else the signal is set to ON. The routine then progresses to the decision node 156, in which it is determined whether the photocell signal is an ON signal or an OFF signal.

If decision node 154 determines that the clock 118 has reached an ON or OFF time, the routine progresses to the decision node 156, where it is queried whether the signal is an ON signal or an OFF signal.

Looking now at the decision node 156, if it is determined that the signal is an ON signal, the routine progresses to decision node 158, where it is determined whether the inflation blower 18 is already running. If the inflation blower 18 is already on and the signal at decision node 158 is another ON signal, no action is taken. The inflation blower remains ON, and the routine returns to decision node 152 to resume the loop 152-154 looking for an input signal. If the inflation blower 18 is not already ON, then the decision node 158 causes an Inflation Routine to execute.

If the decision node 156 determines that the signal is an OFF signal, the routine progresses to decision node 159, where it is determined whether the inflation blower 18 is already off. If the inflation blower 18 is already off and the signal at decision node 159 is another OFF signal, no action is taken. The inflation blower remains off, and the routine returns to decision node 152 to resume the loop 152-154 looking for an input signal. If the inflation blower 18 is not already OFF, then the decision node 159 causes the inflation blower 18 to be turned off at block 160 and causes a Deflation Routine to execute at block 161.

If the routine 150 calls for the Inflation Sequence to execute at block 158, the following steps occur. The inflation blower 18 turns on and begins to inflate the inflatable FIG. 12. A signal is sent to the solenoid 84 of the intake vent damper system 80 to close the damper 82 on the air inlet 77 of the deflation blower 19 (see FIGS. 14 and 15). The inflation blower 18 inflates the inflatable FIG. 12 and continues to run to keep the inflatable figure inflated until action is taken to turn off the inflation blower.

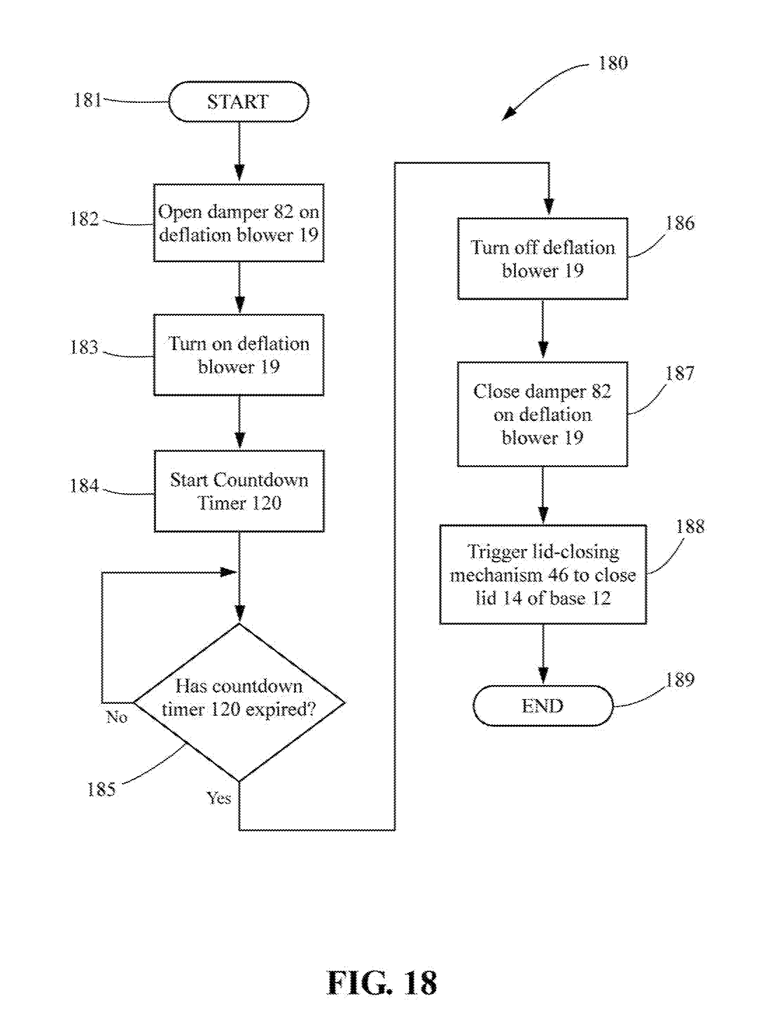

FIG. 18 illustrates the Deflation Sequence subroutine 180 that runs if the algorithm of FIG. 17 reaches node 161. The Deflation Sequence starts at block 181 and proceeds to node 182, where the damper 82 of the intake vent damper system 80 is opened. At node 183 the deflation blower is turned ON. At node 184 the countdown timer 120 is initiated.

The subroutine 180 then enters a monitoring loop at node 185 waiting the expiration of the countdown timer 120. The decision node 185 queries whether the countdown timer has expired, and if the answer is NO, the decision node 185 continues to loop until it detects that the countdown timer has expired.

Once the countdown timer 120 has expired, the subroutine advances to block 186, where the deflation blower 19 is turned off. Then at node 187 the damper 82 of the intake vent damper system 80 on the deflation blower 19 is closed. Then, at block 188, the lid closing mechanism 46 is actuated to close the lid 16. The Deflation Sequence subroutine 180 then ends at block 189.

To inflate the decorative FIG. 12, the inflation blower 18 is turned on, and the blower begins to blow air into the figure. As the inflatable FIG. 12 begins to fill with air, the expanding figure forces open the lid 16 of the base 14. Also, as the inflating FIG. 12 expands, the straps 40 operatively connected to the wall 42 of the figure pull the top of the telescoping pole 30 upward, extending the pole. The FIG. 12 continues to expand until it is fully inflated.

When it is desired to deflate the FIG. 12, the following sequence occurs. The inflation fan 18 is turned off, such as by a manual switch, a wireless signal received by the receiver 106, a clock 118, or a photocell 108. As the inflation fan 18 stops blowing air into the inflatable FIG. 12, the figure begins to collapse of its own weight. The deflation fan 19, which is configured to draw air out of the inflatable FIG. 12, can be activated to speed up the deflation process. Optionally the inflation fan 18 can be reversed to draw air out of the FIG. 12, instead of blowing air into the figure, to speed up the deflation process.

As the FIG. 12 collapses, the telescoping pole 30 is collapsed by the weight of the deflating figure on the top 38 of the pole. The straps 40 attached to the inner surface 42 of the FIG. 12 exert a force on the material of the figure to cause it to collapse essentially straight down into the base 14.

Substantially simultaneously with the inflation blower 18 being turned off, the timer 120 begins counting down. The timer 120 proscribes a period of time sufficient to allow the deflating FIG. 12 to collapse completely into the base 14. This period of time depends on a variety of factors, including variables such as the capacity of the deflation blower 19, the volume and configuration of the inflatable FIG. 12, and the material from which the inflatable figure is made. This duration is determined by trial and error at the factory and programmed into the CPU.

When the timer expires, the lid-closing mechanism 46 is actuated to close the lid 16, enclosing the collapsed inflatable FIG. 12 within the base 14.

The disclosed embodiment enjoys numerous advantages over known inflatable holiday decorations. When deflated, the decoration is collapsed into an attractive base enclosure 14 with lid 16, avoiding the unsightly appearance of a haphazard pile of polyester fabric on the lawn. Also, the base 14 and lid 16 protect the deflated decoration, reducing the possibility of damage. The weight of the base 14 and the fact that the inflatable 12 is anchored to the base reduces or eliminates the need for staking down the decoration 10 or adding separate ballast to prevent the decoration from being toppled or displaced in the wind. Additionally, because the inflatable FIG. 12 collapses itself into the base, the need to spread out the inflatable and fold it or roll it up for storage at the end of the season is eliminated, and the base 14 becomes a protective container for storage during the offseason.

While the embodiment described above is disclosed with respect to a snowman inflatable figure associated with a gift package base, many other variations are possible. An inflatable penguin can collapse into a base configured as an igloo or snowbank. An inflatable Santa can collapse into a base configured as a chimney. An inflatable Halloween witch or goblin can be used with a base having the appearance of a pumpkin. A scarecrow can collapse into a base having the appearance of a hay bale. Virtually any combination of holiday-themed inflatable figures and holiday-associated bases can be used.

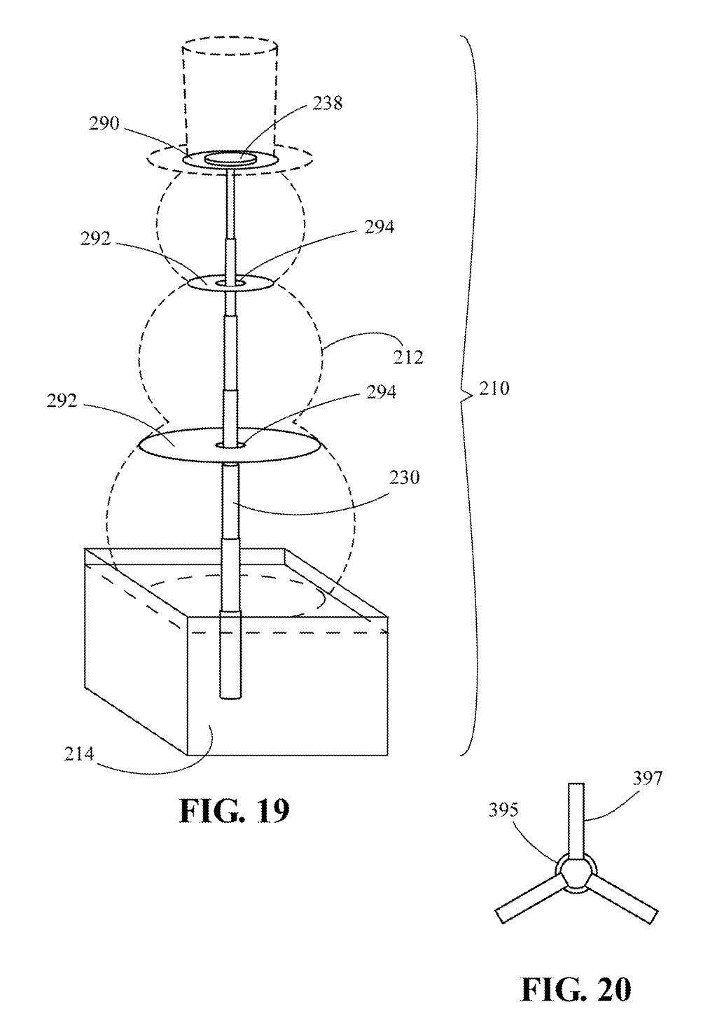

FIG. 19 shows an alternate embodiment of an inflatable decoration 210 comprising an inflatable FIG. 212 and base 214. The lower end of a telescoping pole 230 is mounted within the base 214. An inflation blower (not shown) is mounted to the base 214 to blow air into the inflatable FIG. 212, in the same manner described above with respect to the holiday decoration 10. Optionally, a deflation blower (not shown) is mounted to the base 214 to extract air from the inflatable FIG. 212 to collapse the figure, also as previously explained with respect to the inflatable decoration 10.

An upper disk 290 and a plurality of lower disks 292 are attached to the inside of the inflatable FIG. 212 at vertically spaced apart locations. In the disclosed embodiment, the disks 290, 292 are flexible fabric. The disks 290, 292 are attached to the interior surface of the inflatable figure by stitching, gluing, heat welding, or other suitable fastening means. Each lower disk 292 has a central opening 294. The telescoping pole 230 extends through the central opening 294 of each of the lower disks 290.

The upper disk 290 is attached to the upper end 238 of the telescoping pole 230. The upper disk may or may not have a central opening. The upper disk 290 can be attached to the upper end 238 of the telescoping pole 230 in any of a variety of ways, such as by stitching or adhering the disk to the upper end of the pole, by clamping the upper disk 290 between two opposed disks 238, or by any other suitable means.

As the inflatable FIG. 212 is inflated, it begins to expand. As the FIG. 212 expands, the upper disk 290 is pulled upward, exerting an upward force on the upper end of the telescoping pole 230 that extends the pole. As the sections of the pole 230 telescope upward, the pole slides freely within the central openings 294 of each of the lower disks 292. When the FIG. 212 is fully inflated, the telescoping pole within the figure is attached to the upper disk 290 and slidable within the lower disks 292.

When the inflation blower is turned off, the FIG. 212 begins to collapse. The weight of the collapsing FIG. 212 bearing against the upper end 238 of the telescoping pole 230 causes the pole to begin to collapse downward. The collapsing pole 230 does not necessarily exert vertical force on the lower disks 292 but does maintain the disks in vertical alignment, thereby controlling the collapse of the deflating FIG. 212. This interaction between the telescoping pole 230 and the rings 290, 292 causes the deflating FIG. 212 to collapse as nearly vertical as possible, ensuring that the figure collapses into the base 214. When the FIG. 212 has collapsed, the lid of the box closes, in the same manner described above with respect to the inflatable decoration 10.

FIG. 20 illustrates an alternative to at least the lower disks 292. Rather than a disk extending 360° around the central opening, a ring 395 is attached to the interior of the inflatable FIG. 212 by a plurality of radially extending straps 397. The outer ends of the straps 397 are secured to the interior of the inflatable FIG. 212 by stitching, gluing, held welding, or any other suitable attachment means. The telescoping pole 230 slides freely within the rings 395 as the inflatable FIG. 212 inflates and deflates.

The rings 395 with straps 397 serve in place of at least the lower fabric rings 292 described with respect to FIG. 19. The upper fabric ring 290 can remain as described with respect to FIG. 19, or the upper fabric ring can also be replaced with a ring 395 with straps 397. Or three or four centrally connected straps with no central ring can be used in lieu of the upper ring 290, with the upper end of the telescoping pole 230 being attached to the intersection of the straps.

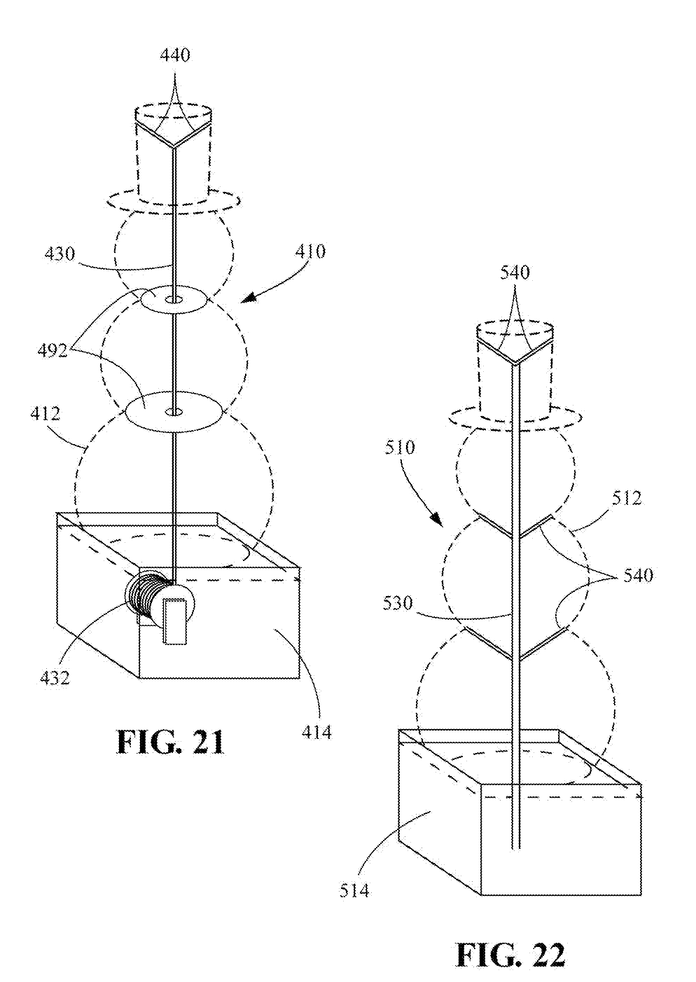

In the guiding means of the previously described embodiments, the telescoping pole is passive, in the sense that it is expanded by the inflating figure pulling upward and collapsed by the weight of the deflating figure pushing downward and does not actively extend or retract. FIGS. 21 and 22 disclose embodiments in which the guiding means actively retracts and assists in collapsing the deflating figure.

Referring to FIG. 21, a further embodiment 410 of an inflatable decoration is illustrated. A conventional motorized winch 432 is mounted within the base 414 inside the inflatable FIG. 412. A cable 430 is wrapped around the drum of the winch 432, and the free end of the cable is attached by straps 440 to the inner surface of the inflatable FIG. 412 at its upper end.

When the inflation blower (not shown in FIG. 21) is turned on, the drum of the winch 432 disengages from the winch drive mechanism, permitting the cable 430 to unwind as the inflating FIG. 412 expands. When the inflation blower is turned off, the drive mechanism of the winch 432 reengages, and the drum rotates to reel in the cable 430. As the cable 430 is retracted, it pulls the upper end of the inflatable FIG. 412 downward, facilitating the deflation of the figure. The cable 430 also ensures that the FIG. 412 collapses in a nearly vertical manner so as to be drawn into the base 414.

The winch 432 of the embodiment 410 need not be located inside the inflatable FIG. 412 in order to exert a downward tension on the cable 430 inside the inflatable figure. As an example, the winch 432 can be mounted outside the inflatable FIG. 412, with a pulley mounted within the base 414 inside the inflatable FIG. 412. The cable 430 extends from the winch 432 and around the pulley such that operation of the winch exerts a substantially vertical, downward tension on the cable 430, despite the winch not being located inside the inflatable FIG. 412. Thus when a winch is said to be arranged to exert a downward tension on a cable inside the inflatable figure, such an arrangement contemplates the possibility of intervening pulleys or other devices that redirect the initial direction of force exerted by the cable, and it is not required that the winch itself be physically located inside the inflatable figure.

FIG. 22 shows an inflatable decoration 510, including an inflatable FIG. 512 and a base 514. An elongated elastic member 530 is located within the FIG. 512 and has its lower end anchored to the floor of the base 514. The elastic member 530 is attached to the inner surface of the figure by straps 540, at least at the upper end of the elastic member, and preferably at a plurality of locations along the length of the elastic member.

When the inflatable FIG. 510 inflates, the expansion of the figure stretches the elongated elastic member 530. When the FIG. 512 deflates, the elastic member 530 contracts, pulling the upper end of the figure vertically downward and into the base 514.

Further variations on the inflatable decoration described above are contemplated. The deflation blower 19 can be omitted, relying on the weight of the inflatable figure to deflate the figure, or in the case of the embodiments of FIGS. 21 and 22, relying on the weight of the figure and the tension exerted by the cable 430 or elastic cord 530. Alternatively, the dedicated deflation blower 19 can be eliminated, and the first blower 18 can be reversed to extract air from the inflatable figure and expedite its deflation. Also, the inflation blower 18, the deflation blower 19, or both can be of a fan type other than centrifugal fans.

In lieu of the motorized lid closer 46, one or more springs can be connected to the base 14 and the lid 16. The expanding force exerted by the inflating FIG. 12 overcomes the resistance of the springs to allow the lid 16 to open. When the inflatable figure deflates and the force holding open the lid is removed, the springs pull the lid closed. Optionally, to prevent the lid 16 from attempting to close prematurely and interfering with the inflatable FIG. 12 collapsing into the base 14, a latch can be employed that keeps the lid open and then releases when the inflatable figure is fully collapsed, only then permitting the springs to draw the lid closed.

While the foregoing embodiments are disclosed with respect to what is referred to herein as a “holiday” decoration, it will be understood that the term “holiday decoration” is used for purposes of identifying the general nature of the article of manufacture, and that the invention is not limited to one that is used only at certain times of the year.

As used herein, words such as top, bottom, left, right, and the like are used with reference to the drawings for convenience of description, and use of these words is not intended to limit the invention to any particular orientation.

Finally, it will be understood that the foregoing embodiments have been disclosed by way of example, and that other modifications may occur to those skilled in the art without departing from the scope and spirit of the appended claims.

What is claimed is:

1. An inflatable decoration, comprising:
an inflatable figure having a lower portion, an upper portion, and an inner surface;
a base defining a space therewithin, said space being sufficiently large to contain said inflatable figure when said figure is in a deflated condition;
said lower portion of said inflatable figure being located within said base;
a blower operatively associated with said inflatable figure, said blower being switchable between an inflation mode in which said blower is operative to force air into said figure to inflate it, and a deflation mode in which said blower allows said inflatable figure to deflate; and
guiding means for guiding the collapse of said inflatable figure when said blower is switched from said inflation mode to said deflation mode, a major portion of said guiding means being disposed within said inflatable figure, said guiding means having an upper end and a lower portion, said upper end attached to said inner surface of said inflatable figure proximate said upper end of said figure, and said lower portion of said guiding means being disposed within said base;
wherein when said inflatable figure deflates, said guiding means guides said inflatable figure to collapse into said space in said base.

2. The inflatable decoration of claim 1, wherein said guiding means comprises a telescoping pole having an upper end and having a lower portion disposed within said base, and wherein said upper end of said telescoping pole is attached to an inner surface of said inflatable figure.

3. The inflatable decoration of claim 1, further comprising means disposed within said inflatable figure for defining an opening, said opening-defining means being secured to said inner surface of said inflatable figure at a location spaced downward from said upper portion of said inflatable figure, and said guiding means extending through said opening.

4. The inflatable decoration of claim 3, wherein said opening-defining means comprises a sheet having a periphery, and wherein said sheet is secured around a major portion of its periphery to said inner surface of said inflatable figure.

5. The inflatable decoration of claim 3, wherein said opening-defining means comprises a ring and a plurality of straps each of which has an inner and an outer end, said inner end of each of said plurality of straps being secured to said ring, and said outer end of each of said plurality of straps being secured to said inner surface of said inflatable figure,
wherein said guiding means passes through said ring.

6. The inflatable decoration of claim 1, wherein said opening-defining means comprises a first opening-defining means, and further comprising a second means disposed within said inflatable figure for defining an opening, said second opening-defining means being secured to said inner surface of said inflatable figure at a location spaced vertically from said first opening-defining means, said openings defined by said first and second opening-defining means being vertically aligned, and said guiding means extending through said openings in said first and second opening-defining means.

7. The inflatable decoration of claim 1, further comprising a lid pivotably mounted to said base.

8. The inflatable decoration of claim 7, further comprising means operative upon collapse of said inflatable figure into said base for closing said lid.

9. The inflatable decoration of claim 1, wherein said guiding means comprises:
a winch; and
a cable having a first end operatively associated with said winch and a second end attached to said inner surface of said inflatable figure proximate said upper end of said figure;
said winch being arranged to exert a downward tension on said cable;
wherein when said blower is switched from said inflation mode to said deflation mode, said winch is operative to exert a tension on said cable that draws said upper end of said inflatable figure into said space in said base.

10. The inflatable decoration of claim 1, wherein said guiding means comprises an elastic member having an upper end attached to said inner surface of said inflatable figure proximate said upper end of said figure, and a second end anchored within said base.

11. An inflatable decoration, comprising:
an inflatable figure having a lower portion, an upper portion, and an inner surface;
a base defining a space therewithin, said space being sufficiently large to contain said inflatable figure when said figure is in a deflated condition;
said lower portion of said inflatable figure being located within said base;
a telescoping pole having an upper end and having a lower portion disposed within said base, said upper end of said telescoping pole being attached to said inner surface of said inflatable figure; and
a blower operatively associated with said inflatable figure, said blower being switchable between an inflation mode in which said blower is operative to force air into said figure to inflate it, and a deflation mode in which said blower allows said inflatable figure to deflate;
whereby when said blower is switched to said inflation mode, said inflatable figure expands, pulling said upper end of said telescoping pole upward and telescopingly expanding said pole;
whereby when said blower is switched from said inflation mode to said deflation mode, said figure deflating forces said upper end of said telescoping pole downward and telescopingly collapses said pole; and
whereby said upper end of said telescoping pole being attached to said inner surface of said inflatable figure exerts a force that causes said inflatable figure to collapse into said space in said base.

12. The inflatable decoration of claim 11, further comprising means disposed within said inflatable figure for defining an opening, said opening-defining means being secured to said inner surface of said inflatable figure at a location spaced downward from said upper portion of said inflatable figure, and said telescoping pole extending through said opening.

13. The inflatable decoration of claim 12, wherein said opening-defining means comprises a sheet having a periphery, and wherein said sheet is secured around a major portion of its periphery to said inner surface of said inflatable figure.

14. The inflatable decoration of claim 12, wherein said opening-defining means comprises a ring and a plurality of straps each of which has an inner and an outer end, said inner end of each of said plurality of straps being secured to said ring, and said outer end of each of said plurality of straps being secured to said inner surface of said inflatable figure,
wherein said telescoping pole passes through said ring.

15. The inflatable decoration of claim 12, wherein said opening-defining means comprises a first opening-defining means, and further comprising a second means disposed within said inflatable figure for defining an opening, said second opening-defining means being secured to said inner surface of said inflatable figure at a location spaced vertically from said first opening-defining means, said openings defined by said first and second opening-defining means being vertically aligned, and said guiding means extending through said openings in said first and second opening-defining means.

16. The inflatable decoration of claim 13, wherein said sheet comprises a first sheet, and further comprising a second sheet disposed within said inflatable figure at a location spaced vertically from said first sheet, said second sheet having a periphery, and said sheet being secured around a major portion of its periphery to said inner surface of said inflatable figure.

17. The inflatable decoration of claim 13, wherein said ring comprises a first ring, and further comprising a second ring and a second plurality of straps each of which has an inner and an outer end, said inner end of each of said second plurality of straps being secured to said second ring, and said outer end of each of said second plurality of straps being secured to said inner surface of said inflatable figure,
wherein said telescoping pole passes through said second ring.

18. The inflatable decoration of claim 11, further comprising a lid pivotably mounted to said base.

19. The inflatable decoration of claim 18, further comprising means operative upon collapse of said inflatable figure into said base for closing said lid.
